(19) United States
(12) Patent Application Publication
(10) Pub. No.: US 2025/0010392 A1
(43) Pub. Date: Jan. 9, 2025

(54) ULTRASONIC-STIRRING NARROW GAP WELDING SYSTEM AND WELDING METHOD

(71) Applicant: JIANGSU UNIVERSITY OF SCIENCE AND TECHNOLOGY, Jiangsu (CN)

(72) Inventors: Xiaoli WANG, Jiangsu (CN); Qingxian HU, Jiangsu (CN); Wenkang LIU, Jiangsu (CN); Guoxiang XU, Jiangsu (CN); Qi ZHANG, Jiangsu (CN); Zibo ZHOU, Jiangsu (CN); Xiaoling YUE, Jiangsu (CN); Zhipeng ZHAO, Jiangsu (CN)

(73) Assignee: JIANGSU UNIVERSITY OF SCIENCE AND TECHNOLOGY, Jiangsu (CN)

(21) Appl. No.: 18/665,589

(22) Filed: May 16, 2024

(30) Foreign Application Priority Data
Jul. 3, 2023 (CN) 202310808522.3

(51) Int. Cl. B23K 9/26; B23K 9/12

(52) U.S. Cl. CPC B23K 9/26; B23K 9/124

(57) ABSTRACT

An ultrasonic-stirring narrow gap welding system and a welding method, and the ultrasonic-stirring narrow gap welding system includes a welding machine power source, a wire feeder, a narrow gap welding torch, and an ultrasonic stirring subsystem. A welding wire is fed into a narrow gap through the narrow gap welding torch provided above a groove, to generate an arc for welding. The ultrasonic stirring subsystem includes a stirrer and an ultrasonic device, a stirring rod is connected to the ultrasonic device and inserted into a molten pool to form a preset angle relative to the welding wire for stirring, and an ultrasonic-stirring narrow gap welding mode is realized.

### CROSS-REFERENCE TO RELATED APPLICATION

This application claims the priority benefit of China application serial no. 202310808522.3, filed on Jul. 3, 2023. The entirety of the above-mentioned patent application is hereby incorporated by reference herein and made a part of this specification.

### BACKGROUND

### Technical Field

The present disclosure relates to the field of narrow gap welding, and in particular, to an ultrasonic-stirring narrow gap welding system and a welding method.

### Description of Related Art

Narrow-gap gas metal arc welding (GMAW) has a high deposition efficiency, avoids interlayer slag removal, and has a large heat input adjusting range. In the narrow-gap GMAW, under conditions that special technologies are not required for welding preheating, interlayer temperature control, post-welding heat treatment, or the like, overheat crispness and weakening of a welded joint are greatly reduced, and a low heat input is quite beneficial to softening of a welding heat affected zone (HAZ), and is helpful to improve a bearing capacity of the welded joint and size precision of a weldment.

However, since an arc is almost parallel to a side wall of a groove in the narrow gap welding, the arc cannot directly heat the side wall under the low heat input, a side-wall incomplete fusion defect is prone to occur, and service safety of a large high-strength steel structure is seriously influenced. In order to improve a welding efficiency of the narrow-gap GMAW, and meanwhile keep advantages of a well-formed weld and high welding quality of the narrow-gap GMAW, a plurality of efficient welding methods have emerged. For example, a strong-mechanical-stirring narrow-gap GMAW molten pool welding method can improve side wall fusion quality, but the technical solution has defects that a rotary stirring force generated during mechanical stirring causes uneven temperature distribution in a molten pool, surface stress is large, a welding process is difficult to control, a welding precision requirement is difficult to meet, and a weld microstructure is uneven.

### SUMMARY

In view of the above problems, an objective of the present disclosure is to provide an ultrasonic-stirring narrow gap welding system and a welding method, to solve problems of an uneven weld microstructure, severe weld porosity, insufficient side wall fusion, or the like, in narrow gap arc welding, realize a uniform weld microstructure, improve a welding efficiency, and realize efficient and high-quality narrow gap arc welding.

The present disclosure provides the following technical solution.

An ultrasonic-stirring narrow gap welding system is provided, including a welding machine power source, a wire feeder, and a narrow gap welding torch, and further including an ultrasonic stirring subsystem, where the ultrasonic stirring subsystem includes an ultrasonic device and a stirrer, the ultrasonic device includes an ultrasonic vibration power source, a transducer, an amplitude transformer, and a converter which are sequentially connected, the converter is fixed on an upper portion of the stirrer, the narrow gap welding torch is provided vertically above a U-shaped groove of a to-be-welded workpiece, and a welding wire in the wire feeder is fed into the groove through the narrow gap welding torch; a positive pole of the welding machine power source is connected with the welding wire in the narrow gap welding torch, and a negative pole of the welding machine power source is connected with the to-be-welded workpiece; the stirrer is provided on one side of the narrow gap welding torch, a stirring rod of the stirrer is obliquely inserted into the groove relative to the welding wire, and an end portion of the stirring rod is inserted into a molten pool in the groove for stirring during working.

Further, an inclination angle of the stirring rod relative to the welding wire is 15° to 60°, and a horizontal distance between the end portion of the stirring rod and an end portion of the welding wire is 10 mm.

Further, a distance from the end portion of the welding wire to a surface of the groove of the to-be-welded workpiece is 5 mm to 8 mm.

Further, the end portion of the stirring rod is of a rotary paddle type or a cylinder type or a rotary wheel type.

Further, the stirring rod is made of tungsten or vanadium or ceramic which is a high temperature resistant material, to avoid melting of the stirring rod due to an over high temperature of an arc, thereby preventing impurities in a weld.

Preferably, a rotating speed of the stirring rod is 0 rps to 1,200 rps, and an ultrasonic vibration frequency of the ultrasonic vibration power source is 30 kHz to 50 kHz.

Preferably, a welding current of the welding machine power source is 50 A to 400 A, and a gas flow in the narrow gap welding torch is 30 L/min.

A welding method based on the ultrasonic-stirring narrow gap welding system is provided, including the following steps:
step 1: taking the to-be-welded workpiece, polishing or cleaning a surface of the to-be-welded workpiece, fixing the to-be-welded workpiece on a welding tool fixture of a welding platform, forming the U-shaped groove in the to-be-welded workpiece, pressing four corners of the to-be-welded workpiece, and turning on water, electricity, and gas;
step 2: selecting direct current reverse polarity as a welding current mode;
step 3: turning on the ultrasonic vibration power source and a stirrer power source, and adjusting a position of the stirrer to enable the stirring rod to be obliquely fixed in the groove;
step 4: setting stirring parameters and welding parameters, where the stirring parameters include a stirring rotating speed, a stirring excitation voltage, a stirring rod radius, and an ultrasonic frequency, and the stirring rod with a selected radius model is mounted on the stirrer; the welding parameters include a welding current, a welding speed, a nozzle height, and a protective gas flow, and the welding speed is controlled by controlling a moving speed of the welding platform;
step 5: regulating and controlling a position of the narrow gap welding torch to position the welding wire at a center of the groove, and after other parameters are set, starting a combined control switch, starting the welding platform for welding, starting the narrow gap welding torch to generate a welding arc, feeding the welding wire to the arc by the wire feeder, starting the welding, and forming the molten pool on the surface of the to-be-welded workpiece;
step 6: adjusting the stirrer again to allow an insertion depth of the stirring rod into the molten pool to meet a requirement, adjusting an angle between the stirring rod and the welding wire to stagger the narrow gap welding torch and the stirring rod from front to back along a welding direction, adjusting the rotating speed of the stirring rod and the ultrasonic frequency of the ultrasonic device, transmitting generated ultrasonic waves to the molten pool through the stirring rod, and meanwhile starting to stir the molten pool by the stirring rod; and
step 7: after the welding of a whole weld is finished to obtain a welded workpiece, turning off the welding machine power source, the ultrasonic vibration power source, and the stirrer power source, air-cooling the welded workpiece to a room temperature, taking down the welded workpiece, and wiping up a surface of the welded workpiece to finish the welding.

Preferably, the welding speed is 140 mm/min to 400 mm/min, the stirring rod radius is 1.5 mm to 2 mm, and the stirring excitation voltage is 5 VDC.

Preferably, the insertion depth of the stirring rod into the molten pool is 1 mm to 3 mm.

In the present disclosure, the stirring rod is connected to the ultrasonic device, and then, the stirring rod is inserted into the molten pool for stirring, such that an ultrasonic-stirring narrow gap welding mode is realized, and ultrasonic stirring and mechanical stirring effects are simultaneously added in the welding system.

The ultrasonic stirring subsystem, on one hand, carries out mechanical stirring. The molten pool flows to form a vortex, which is beneficial to accelerating of heat exchange, and arc heat of the molten pool is effectively transferred to a side wall, such that temperature distribution is more uniform, penetration of the side wall is increased, finger-shaped penetration is prevented from being formed at a bottom of the weld, a crack tendency is reduced, and weld quality is improved. Gas in molten metal escapes under an action of sufficient stirring in the welding molten pool, thus reducing occurrence of air holes and facilitating uniform distribution of elements in the molten pool. On the other hand, under an action of ultrasonic stirring, on the basis of the original mechanical stirring, a grain refinement effect is greatly enhanced, the finger-shaped penetration is prevented from being formed at the bottom of the weld, a side wall cladding efficiency is improved, a structure of a narrow gap welded joint is homogenized, and toughness of the welded joint is improved.

Compared with heat input of traditional narrow gap arc welding, in the present disclosure, the heat input of a traditional narrow gap arc welding process is basically not changed, thus effectively avoiding an adverse effect of additional heat input on grain refinement. Meanwhile, the ultrasonic and mechanical stirring method has advantages of a simple device, a low cost, and convenient operation. A high shearing rate, strong adaptability, or the like, can be achieved. A high efficiency and a low cost of welding production and processing is achieved, and a wide industrial application prospect is realized.

### BRIEF DESCRIPTION OF THE DRAWINGS

FIG. 1 is a schematic structural diagram of a system according to the present disclosure.

FIG. 2 is a flow chart of a working method according to the present disclosure.

FIG. 3A is a metallographic structure diagram of a narrow gap welded workpiece obtained without stirring, and FIG. 3B is a metallographic structure diagram of a narrow gap welded workpiece welded using the welding method according to the present disclosure.

In the drawings: 1. welding machine power source; 2. wire feeder; 21. welding wire; 3. narrow gap welding torch; 31. stirring rod; 4. signal-connected ultrasonic vibration power source; 5. transducer; 6. amplitude transformer; 61. molten pool; 7. converter; 8. stirrer; 9. stirrer power source; 10. to-be-welded workpiece.

### DESCRIPTION OF THE EMBODIMENTS

The present disclosure will be further illustrated with reference to the accompanying drawings and specific embodiments, and it should be understood that these embodiments are intended to only illustrate the present disclosure and not to limit the scope of the present disclosure.

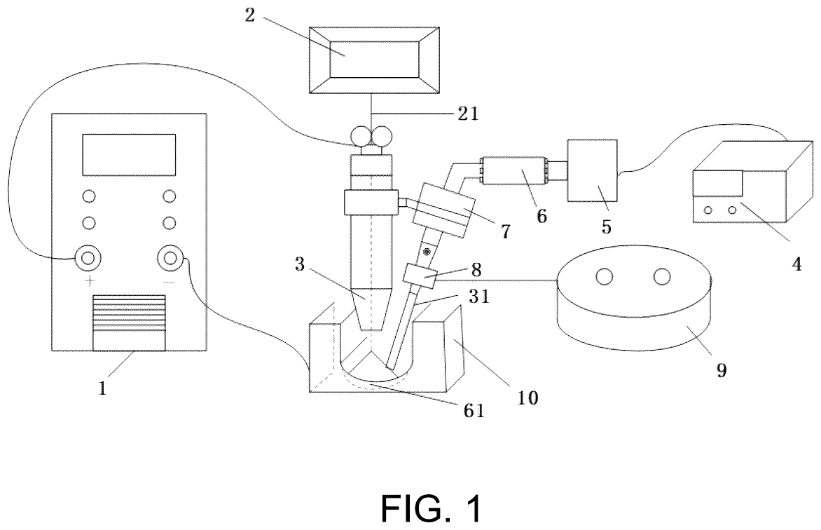

As shown in FIG. 1, an ultrasonic-stirring narrow gap welding system according to the present disclosure includes a welding machine power source 1, a wire feeder 2, a narrow gap welding torch 3, and an ultrasonic stirring subsystem, where the ultrasonic stirring subsystem includes an ultrasonic device and a stirrer 8, the ultrasonic device includes an ultrasonic vibration power source 4, a transducer 5, an amplitude transformer 6, and a converter 7 which are sequentially connected by signals, the converter 7 is fixed on an upper portion of the stirrer 8, a U-shaped groove is formed in a to-be-welded workpiece 10, the narrow gap welding torch 3 is provided vertically above the U-shaped groove, and a welding wire 21 in the wire feeder 2 is fed into the U-shaped groove through the narrow gap welding torch 3. A positive pole of the welding machine power source 1 is connected with the welding wire 21 in the narrow gap welding torch 3, a negative pole of the welding machine power source 1 is connected with the to-be-welded workpiece 10, the stirrer 8 is provided on one side of the narrow gap welding torch 3 and connected with a stirrer power source (9), a stirring rod 31 of the stirrer 8 is obliquely inserted into the U-shaped groove relative to the welding wire 21, and an end portion of the stirring rod 31 is inserted into a molten pool 61 in the U-shaped groove for stirring during working.

An inclination angle of the stirring rod 31 relative to the welding wire 21 is 15° to 60°, and a horizontal distance between the end portion of the stirring rod 31 and an end portion of the welding wire 21 is 10 mm; a distance from the end portion of the welding wire 21 to a surface of the groove of the to-be-welded workpiece 10 is 5 mm to 8 mm. The end portion of the stirring rod 31 is of a rotary paddle type or a cylinder type or a rotary wheel type; the stirring rod 31 is made of a high-temperature resistant material, such as tungsten, vanadium, or ceramic. A rotating speed of the stirring rod 31 is 0 rps to 1,200 rps, and an ultrasonic vibration frequency of the ultrasonic vibration power source 4 is 30 kHz to 50 kHz. A welding current of the welding machine power source 1 is 50 A to 400 A, and a gas flow in the narrow gap welding torch 3 is 30 L/min.

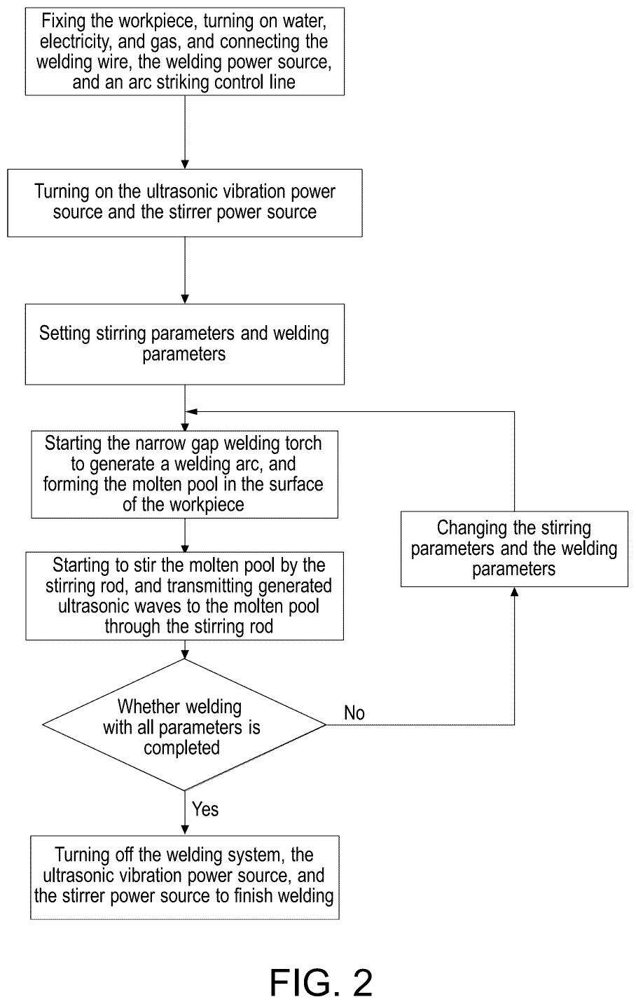

As shown in FIG. 2, a welding method based on the ultrasonic-stirring narrow gap welding system includes the following steps.
Step 1: the to-be-welded workpiece 10 is taken, a surface of the to-be-welded workpiece 10 is polished or cleaned, the to-be-welded workpiece 10 is fixed on a welding tool fixture of a welding platform, the U-shaped groove is formed in the to-be-welded workpiece 10, four corners of the to-be-welded workpiece 10 are pressed, and water, electricity, and gas are turned on; according to a connecting method of the welding system, the welding wire in the narrow gap welding torch, the welding power source, and an arc striking control line are connected.
Step 2: direct current reverse polarity is selected as a welding current mode, the positive pole of the welding machine power source 1 is connected with the welding wire 21 in the narrow gap welding torch 3, and the negative pole of the welding machine power source 1 is connected with the workpiece 10.
Step 3: the ultrasonic vibration power source 4 and the stirrer power source 9 are turned on, and a position of the stirrer 8 is adjusted to enable the stirring rod of the stirrer 8 to be obliquely fixed in the U-shaped groove.
Step 4: ultrasonic stirring parameters and welding parameters are set, where the ultrasonic stirring parameters include a stirring rotating speed, a stirring excitation voltage, a stirring rod radius, and an ultrasonic frequency, the stirring rod with a determined model is obliquely mounted on the stirrer, the stirring excitation voltage is 5 VDS, and the stirring rod radius is 1.5 mm to 2 mm; the welding parameters include a welding current, a welding speed, a nozzle height, and a protective gas flow, the welding speed is controlled by controlling a moving speed of the welding platform, and the welding speed is 140 mm/min to 400 mm/min.
Step 5: a position of the narrow gap welding torch is regulated and controlled to position the welding wire at a center of the groove, and the distance from the end portion of the welding wire 21 to the surface of the U-shaped groove of the to-be-welded workpiece 10 is 5 mm to 8 mm. A combined control switch is started, the welding platform is started for welding, the narrow gap welding torch is started to generate a welding arc, the welding wire is fed to the arc by the wire feeder, welding is started, and the molten pool is formed on the surface of the to-be-welded workpiece 10.
Step 6: the stirring rod 31 is gradually inserted into the molten pool 61 by 1 mm to 3 mm, an angle between the stirring rod 31 and the welding wire 21 is adjusted to 15° to 60° to stagger the narrow gap welding torch 3 and the stirring rod 31 from front to back along a welding direction, and the horizontal distance between the end portion of the stirring rod 31 and the end portion of the welding wire 21 is 10 mm. The rotating speed of the stirring rod 31 and the ultrasonic frequency of the ultrasonic vibration power source 4 are adjusted, generated ultrasonic waves are transmitted to the molten pool 61 through the stirring rod 31, and meanwhile, the stirring rod 31 starts to stir the molten pool 61.
Step 7: after the welding of a whole weld is finished to obtain a welded workpiece, the welding machine power source 1, the ultrasonic vibration power source 4 and the stirrer power source 9 are turned off, the welded workpiece is air-cooled to a room temperature, the welded workpiece is taken down, and a surface of the welded workpiece is wiped up to finish the welding.

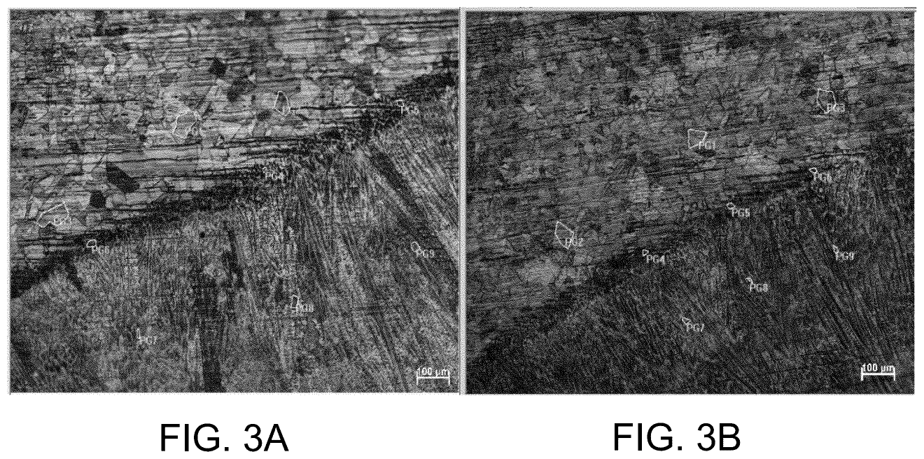

FIGS. 3A and 3B are metallographic structure diagrams of unstirred and stirring-assisted narrow gap welded workpieces, respectively, and by comparison, the welding method according to the present disclosure can effectively reduce bubbles, refine grains and make a structure at a welded joint uniform.

In a specific embodiment, in order to protect a heating zone in a welding process, guarantee stable welding and ensure that the weld is not deformed by air entering in the welding process, a protective gas zone is filled with inert protective gas, such as argon, or the like, in the present disclosure, and the gas is not limited and fixed in the present disclosure and can be selected according to an actual situation.

The present disclosure has wide applicability, is suitable for welding metal materials, such as steel, or the like, and is suitable for both consumable electrode arc welding and non-consumable electrode arc welding.

What is claimed is:

1. An ultrasonic-stirring narrow gap welding system, comprising:
a welding machine power source, a wire feeder, and a narrow gap welding torch, and further comprising an ultrasonic stirring subsystem, wherein the ultrasonic stirring subsystem comprises an ultrasonic device and a stirrer, the ultrasonic device comprises an ultrasonic vibration power source, a transducer, an amplitude transformer, and a converter which are sequentially connected, and the converter is fixed on an upper portion of the stirrer; the narrow gap welding torch is provided vertically above a U-shaped groove of a to-be-welded workpiece, and a welding wire in the wire feeder is fed into the U-shaped groove through the narrow gap welding torch; a positive pole of the welding machine power source is connected with the welding wire in the narrow gap welding torch, and a negative pole of the welding machine power source is connected with the to-be-welded workpiece; the stirrer is provided on one side of the narrow gap welding torch and connected with a stirrer power source, a stirring rod of the stirrer is obliquely inserted into the U-shaped groove relative to the welding wire, and an end portion of the stirring rod is inserted into a molten pool in the U-shaped groove for stirring during working.

2. The ultrasonic-stirring narrow gap welding system according to claim 1, wherein an inclination angle of the stirring rod relative to the welding wire is 15° to 60°, and a horizontal distance between the end portion of the stirring rod and an end portion of the welding wire is 10 mm.

3. The ultrasonic-stirring narrow gap welding system according to claim 2, wherein a distance from the end portion of the welding wire to a surface of the U-shaped groove of the to-be-welded workpiece is 5 mm to 8 mm.

4. The ultrasonic-stirring narrow gap welding system according to claim 1, wherein the end portion of the stirring rod is of a rotary paddle type or a cylinder type or a rotary wheel type.

5. The ultrasonic-stirring narrow gap welding system according to claim 1, wherein the stirring rod is made of tungsten or vanadium or ceramic.

6. The ultrasonic-stirring narrow gap welding system according to claim 1, wherein a rotating speed of the stirring rod is 0 rps to 1,200 rps, and an ultrasonic vibration frequency of the ultrasonic vibration power source is 30 kHz to 50 kHz.

7. The ultrasonic-stirring narrow gap welding system according to claim 1, wherein a welding current of the welding machine power source is 50 A to 400 A, and a gas flow in the narrow gap welding torch is 30 L/min.

8. A welding method based on the ultrasonic-stirring narrow gap welding system according to claim 1, comprising the following steps:
step 1: taking the to-be-welded workpiece, polishing or cleaning a surface of the to-be-welded workpiece, fixing the to-be-welded workpiece on a welding tool fixture of a welding platform, forming the U-shaped groove in the to-be-welded workpiece, pressing four corners of the to-be-welded workpiece, and turning on water, electricity, and gas;
step 2: selecting direct current reverse polarity as a welding current mode, connecting the positive pole of the welding machine power source with the welding wire in the narrow gap welding torch, and connecting the negative pole of the welding machine power source with the to-be-welded workpiece;
step 3: mounting the stirring rod on the stirrer, turning on the ultrasonic vibration power source and the stirrer power source, and adjusting a position of the stirrer to enable the stirring rod to be obliquely fixed in the U-shaped groove;
step 4: setting ultrasonic stirring parameters and welding parameters, wherein the ultrasonic stirring parameters comprise a stirring rotating speed, a stirring excitation voltage, a stirring rod radius, and an ultrasonic frequency; the welding parameters comprise a welding current, a welding speed, a nozzle height, and a protective gas flow, and the welding speed is controlled by controlling a moving speed of the welding platform;
step 5: regulating and controlling a position of the narrow gap welding torch to position the welding wire vertically at a center of the U-shaped groove, starting a combined control switch, starting the welding platform for welding, starting the narrow gap welding torch to generate a welding arc, feeding the welding wire to the arc by the wire feeder, starting the welding, and forming the molten pool on the surface of the to-be-welded workpiece;
step 6: adjusting the stirrer again to allow an insertion depth of the stirring rod into the molten pool to meet a requirement, adjusting an angle between the stirring rod and the welding wire to stagger the narrow gap welding torch and the stirring rod from front to back along a welding direction, adjusting a rotating speed of the stirring rod and the ultrasonic frequency of the ultrasonic device, transmitting generated ultrasonic waves to the molten pool through the stirring rod, and meanwhile starting to stir the molten pool by the stirring rod; and
step 7: after the welding of a whole weld is finished to obtain a welded workpiece, turning off the welding machine power source, the ultrasonic vibration power source, and the stirrer power source, air-cooling the welded workpiece to a room temperature, taking down the welded workpiece, and wiping up a surface of the welded workpiece to finish the welding.

9. The welding method based on the ultrasonic-stirring narrow gap welding system according to claim 8, wherein the welding speed is 140 mm/min to 400 mm/min, the stirring rod radius is 1.5 mm to 2 mm, and the stirring excitation voltage is 5 VDC.

10. The welding method based on the ultrasonic-stirring narrow gap welding system according to claim 8, wherein the insertion depth of the stirring rod into the molten pool is 1 mm to 3 mm.
